(19) United States
(12) Patent Application Publication
(10) Pub. No.: US 2015/0025791 A1
(43) Pub. Date: Jan. 22, 2015

(54) METHOD FOR OPERATING A SAFETY SYSTEM FOR A MOTOR VEHICLE AND SAFE SYSTEM FOR A MOTOR VEHICLE

(71) Applicant: GM GLOBAL TECHNOLOGY OPERATIONS LLC, Detroit, MI (US)

(72) Inventors: Johannes Huth, Trebur (DE); Bruno Praunsmaendel, Ruesselsheim (DE)

(21) Appl. No.: 14/334,508

(22) Filed: Jul. 17, 2014

(30) Foreign Application Priority Data
Jul. 18, 2013 (DE) 102013011962.6

(51) Int. Cl. G01C 21/34; G01C 21/36

(52) U.S. Cl. CPC G01C 21/3492; G01C 21/3667
USPC 701/423; 701/301

(57) ABSTRACT

A method for operating a safety system for a motor vehicle is disclosed. The method includes determining when there is a possible hazard situation in a part region of a road with a limited switching possibility for motor vehicles to switch to a region arranged adjacent to the road. A position of the determined possible hazard situation relative to at least one vehicle-external infrastructure device of the safety system is then determined A possible escape route for avoiding the determined possible hazard situation is determined based on the determined position of the possible hazard situation relative to the at least one vehicle-external infrastructure device. A message containing information regarding the determined possible escape route may be sent by means of a transceiver of the at least one infrastructure device to a transceiver of the motor vehicle.

### CROSS REFERENCE TO RELATED APPLICATION

This application claims priority to German Patent Application No. 102013011962.6 filed Jul. 18, 2013, which is incorporated herein by reference in its entirety.

### TECHNICAL FIELD

The present disclosure relates to a method for operating a safety system for a motor vehicle, a safety system for a motor vehicle, a computer program product and a computer-readable medium.

### BACKGROUND

From DE 10 2011 003 043 A1 a method for guiding at least one object, in particular a person and/or group of persons is disclosed. The method includes at least the following steps: establishing a first position of the object to be guided and transmitting a first acoustic information to the object to be guided in the first position, wherein transmitting the first acoustic information substantially takes place focused on the first position of the object to be guided.

### SUMMARY

The object of an embodiment of the present disclosure is to describe a method for operating a safety system for a motor vehicle, a safety system for a motor vehicle, a computer program product and a computer-readable medium, which make possible a further improved reaction to hazard situations.

In particular, a method for operating a safety system for at least one motor vehicle is described. The safety system includes at least one sending and receiving device or first transceiver and at least one vehicle-external infrastructure device. The at least one infrastructure device includes a sending and receiving device or second transceiver and is arranged adjacent to a part region of a road. According to an aspect of the present disclosure the part region of the road has a limited switching possibility for motor vehicles to switch to a region arranged adjacent to the road according to the following steps: Determining when there is a possible hazard situation in the part region of the road having a limited switching possibility. When it is determined that there is a possible hazard situation in the part region of the road having a limited switching possibility, determining a position of the determined possible hazard situation relative to the at least one vehicle-external infrastructure device. In addition, a possible escape route for avoiding the determined possible hazard situation is determiner based on the determined position of the possible hazard situation relative to the at least one vehicle-external infrastructure device. Furthermore, a message is sent by means of the second transceiver to the first transceiver, wherein the message contains information regarding the determined possible escape route.

A part region of a road having a limited switching possibility for motor vehicles to switch to a region arranged adjacent to the road here and in the following is to mean that the region arranged adjacent to the road can be traveled on to a limited extent or not at all. Such part regions of roads are for example present in tunnels, on bridges, in underpasses, on mountain roads or on dams as well as in multi-level parking lots or underground car parks.

The method according to the mentioned embodiment makes possible a further improved reaction to hazard situations in regions of a road, with a limited switching possibility for motor vehicles. This is affected in particular by determining whether there is a possible hazard situation in the part region of the road having a limited switching possibility. A possible escape route for avoiding the determined possible hazard situation is determined based on the position of the possible hazard situation relative to the infrastructure device and by the sending a message to the at least one motor vehicle with information containing the determined possible escape route. This is based on the consideration that motor vehicles increasingly possess transceivers, by means of which communication with other motor vehicles and fixed, roadside infrastructure devices is possible. By means of the shown embodiment, such infrastructure devices, which are also called roadside units, can be advantageously employed in order to provide motor vehicles, which are present in the transmission region of the transceiver of the respective infrastructure device in as short as possible a time with information regarding a possible escape route for avoiding a hazard situation in the part region of the road having a limited switching possibility.

In an embodiment of the method, a current position of the motor vehicle is additionally determined and the position data containing the determined current position of the motor vehicle provided to the at least one infrastructure device. In the mentioned embodiment, determining the possible escape route additionally takes place based on the position data containing the determined current position of the motor vehicle. As a result, the escape route can be adapted to the current position of the motor vehicle to as accurate a degree as possible.

Here, determining the current position of the motor vehicle can take place by means of, for example, a satellite-supported position determining device or GPS of the motor vehicle. The position data containing the determined current position is transmitted to the transceiver of the at least one infrastructure device by means of the transceiver of the motor vehicle. Additionally or alternatively, the current position of the motor vehicle can be determined by means of the at least one infrastructure device based on data determined by at least one sensor.

Furthermore, the at least one infrastructure device can include a storage device with map data, wherein the map data includes information regarding a course of the road at least in the part region of the road having a limited switching possibility. The possible escape route in the mentioned configuration is additionally determined based on the map data. This makes it possible to adapt the escape route to as accurate as possible a degree to the respective surrounding conditions of the road.

In a further embodiment of the method, a type of the determined possible hazard situation is additionally determined The possible escape route in the mentioned embodiment additionally is determined based on the determined type of the determined possible hazard situation. This in turn makes possible a further improved determining of the possible escape route.

In addition, outputting of a message containing the received information regarding the determined possible escape route by means of an output device of the motor vehicle preferably takes place. As a result, the occupants of the motor vehicle, in particular the driver of the motor vehicle can be reliably informed regarding the determined possible escape route.

Additionally or alternatively, the received information regarding the determined possible escape route can be transmitted to at least one driver assistance system of the motor vehicle. The at least one driver assistance system is designed for automatically actuating at least one element of the motor vehicle, selected from the group consisting of a braking device, a driving device, a steering device and a warning device. In the mentioned configuration, at least one operating parameter of the motor vehicle is adapted by means of the at least one driver assistance system based on the information.

Here, adapting the at least one operating parameter of the motor vehicle can include in particular automatic deactivating of a prime mover or engine of the motor vehicle and/or automatic activating of the motor vehicle's lighting, such as a hazard warning flasher system of the motor vehicle. As a result, in the first-mentioned case, the motor vehicle is prevented from further approaching the possible hazard situation further, or in the second case mentioned, other road users can be warned of the possible hazard situation and/or against the suddenly stopping motor vehicle.

Furthermore, based on the information regarding the determined possible escape route, a semi-autonomous or autonomous traveling of the determined possible escape route by the motor vehicle can take place.

In addition, based on the information regarding the determined possible escape route, at least one illuminating device of the motor vehicle can be automatically activated in such a manner that the determined possible escape route is located at least partially within a region illuminated by means of the at least one illuminating device. As a result, the occupants of the motor vehicle can be supported in the escape to a further improved degree in that the escape route is illuminated, for example by means of a swivel-type headlamp of the motor vehicle.

Furthermore, the information regarding the determined possible escape route can be transmitted to at least one other motor vehicle by means of the transceiver of the motor vehicle. As a result, other road users can be warned of the possible hazard situation at as early as possible a time and the road users may be additionally provided with an escape route at as early as possible a time.

Determining as to whether there is a possible hazard situation in the part region of the road having a limited switching possibility preferably takes place by means of the at least one infrastructure device based on data determined by a sensor arranged adjacent to the part region of the road having a limited switching possibility. As a result, the possible hazard situation can be automatically determined by means of the at least one infrastructure device. Additionally or alternatively, a possible hazard situation can be determined by a human monitor, for example based on images taken by an optical camera and the at least one infrastructure device supplied with such information.

A further aspect of the present disclosure relates to a safety system for a motor vehicle. The safety system includes at least one sending and receiving device or transceiver arranged in the motor vehicle. In addition, the safety system includes at least one vehicle-external infrastructure device. The at least one infrastructure device includes a sending and receiving device or transceiver and is arranged adjacent to a part region of a road having a limited switching possibility for motor vehicles to switch to a region arranged adjacent to the road. In addition to this, the safety system includes a first determining device configured to determine whether there is a possible hazard situation in the part region of the road having an at least limited switching possibility. Furthermore, the safety system includes a second determining device configured to determining a position of the determined possible hazard situation relative to the at least one vehicle-external infrastructure device when it is determined that there is a possible hazard situation in the part region of the road having a limited switching possibility. Furthermore, the safety system includes a third determining device configured to determine a possible escape route for avoiding the determined possible hazard situation based on the determined position of the possible hazard situation relative to the at least one vehicle-external infrastructure device. The at least one vehicle-internal infrastructure device is additionally designed for sending a message containing information regarding the determined possible escape route by means of the transceiver of the at least one infrastructure device to the transceiver of the motor vehicle.

The safety system according to the mentioned embodiment has the advantages already mentioned in connection with the relevant methods, which are not mentioned again at this point to avoid repetitions.

Preferably, the transceiver of the motor vehicle includes a vehicle-to-infrastructure communication device which is also called car-to-infrastructure (C2I) or vehicle-to-roadside (V2R) communication. The safety system additionally includes in a further embodiment an output device configured to output a message within the vehicle containing the information regarding the determined possible escape route. Furthermore, the safety system can additionally include an adapting device configured to adapt at least one operating parameter of the motor vehicle by means of at least one driver assistance system of the motor vehicle based on the information regarding the determined possible escape route. The motor vehicle is for example a passenger car or a utility vehicle.

A further aspect of the present disclosure relates to a computer program product executable on a computer unit of a safety system for at least one motor vehicle. The safety system includes at least transceiver arranged in the motor vehicle and at least one vehicle-external infrastructure device. The at least one infrastructure device includes a transceiver and is arranged adjacent to a part region of a road having a limited switching possibility for motor vehicles to switch to a region arranged adjacent to the road. The computer unit instructs the safety system to carry out the following steps: (i) determining whether there is a possible hazard situation in the part region of the road having a limited switching possibility; (ii) determining a position of the determined possible hazard situation relative to the at least one vehicle-external infrastructure device when it is determined that there is a possible hazard situation in the part region of the road having an at least limited switching possibility; (iii) determining a possible escape route for avoiding the determined possible hazard situation based on the determined position of the possible hazard situation relative to the at least one vehicle-external infrastructure device; (iv) sending a message containing information regarding the determined possible escape route by means of the transceiver of the at least one infrastructure device to the transceiver of the motor vehicle. Additionally, a further aspect of the present disclosure relates to a computer-readable medium, on which a computer program product according to the mentioned embodiment is stored. The computer program product and the computer-readable medium according to the mentioned embodiments have the advantages already mentioned in the connection with the relevant methods, which are not mentioned again at this point to avoid repetitions.

A further aspect of the present disclosure relates to a device for operating a safety system for a motor vehicle. The safety system includes at least transceiver arranged in the motor vehicle and at least one vehicle-external infrastructure device. The at least one infrastructure device includes a transceiver and is arranged adjacent to a part region of a road having a limited switching possibility for motor vehicles to switch to a region arranged adjacent to the road. The device for operating the safety system includes means for determining whether there is a possible hazard situation in the part region of the road having an at least limited switching possibility. In addition, the device includes means for determining a position of the determined possible hazard situation relative to the at least one vehicle-external infrastructure device when it is determined that there is a possible hazard situation in the part region of the road having an at least limited switching possibility. Furthermore, the device includes means for determining a possible escape route for avoiding the determined possible hazard situation based on the determined position of the possible hazard situation relative to the at least one vehicle-external infrastructure device. In addition, the device includes means for sending a message containing information regarding the determined possible escape route by means of the transceiver of the at least one infrastructure device to the transceiver of the motor vehicle. By means of the mentioned device for operating a safety system for a motor vehicle a further improved reaction to hazard situations is made possible as already explained.

In a further embodiment, the device for operating the safety system additionally includes means for outputting a message within the motor vehicle containing the information regarding the determined possible escape route. Furthermore, the device for operating the safety system can include means for adapting at least one operating parameter of the motor vehicle by means of a driver assistance system of the motor vehicle based on the information regarding the determined possible escape route.

### BRIEF DESCRIPTION OF THE DRAWINGS

The present disclosure will hereinafter be described in conjunction with the following drawing figures, wherein like numerals denote like elements, and:

FIG. 1 shows a flow diagram of a method for operating a safety system for a motor vehicle according to a first embodiment of the present disclosure;

FIG. 2 shows a flow diagram of a method for operating a safety system for a motor vehicle according to a second embodiment of the present disclosure;

FIG. 3 shows an example of a traffic situation, in which the methods according to the present disclosure can be employed;

FIG. 4 shows an example of a further traffic situation, in which the methods according to the present disclosure can be employed; and

FIG. 5 shows a safety system for a motor vehicle according to an embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

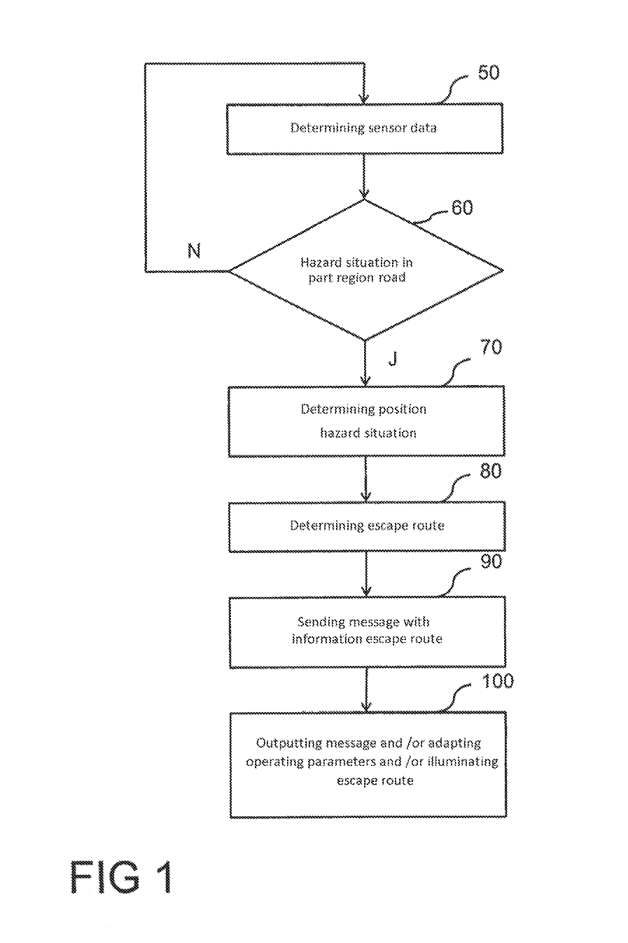

FIG. 1 shows a flow diagram of a method for operating a safety system for a motor vehicle according to a first embodiment of the present disclosure. The motor vehicle is for example a passenger car or a utility vehicle. The safety system additionally includes a sending and receiving device or first transceiver arranged in the motor vehicle and at least one vehicle-external infrastructure device. The at least one infrastructure device in this case includes a sending and receiving device or second transceiver and is arranged adjacent to a part region of a road having a limited switching possibility for motor vehicles to switch to a region arranged adjacent to the road. For example, the at least one infrastructure device is arranged in a tunnel

In the shown embodiment, data is determined at step 50 in FIG. 1 by means of at least one sensor arranged adjacent to the part region of the road having a limited switching possibility takes place. For example, an optical camera and/or a motion-recording device may determine data, for example by means of a sensor designed as a smoke detector.

Based on the sensor data determined in the step 50, whether there is a possible hazard situation in the part region of the road having an at least limited switching possibility is determined in a step 60. Determining whether there is a possible hazard situation in the part region of the road having a limited switching possibility in this case can take place automatically by means of the at least one infrastructure device based on the data determined by the at least one sensor. Furthermore, a possible hazard situation can be inferred based on the data determined by the at least one sensor with the help of a monitor transmitting information to the at least one infrastructure device.

In the case that it is determined in the step 60 that there is no hazard situation in the part region of the road having a limited switching possibility, the steps 50 and 60 are carried out repeatedly.

In the case that it is determined in the step 60, that there is a possible hazard situation in the part region of the road having an at least limited switching possibility, a position of the determined possible hazard situation relative to the at least one vehicle-external infrastructure device is determined in a step 70. This can likewise take place based on the data of the at least one sensor determined in the step 50.

In a step 80,a possible escape route for avoiding the determined possible hazard situation is determined based on the position of the possible hazard situation determined in the step 70 relative to the at least one vehicle-external infrastructure device. For example, the possible escape route is determined in such a manner that motor vehicles, which are located in the part region of the road having a limited switching possibility, do not approach the hazard location any further. The possible escape route is determined preferably affected by means of the at least one infrastructure device. Furthermore, the possible escape route can be affected by a monitor.

In a step 90, a message is sent by means of the transceiver of the at least one infrastructure device at least to the transceiver of the motor vehicle. Here, the message contains information regarding the determined possible escape route.

Furthermore, outputting a message containing information regarding the determined possible escape route by means of an output device of the motor vehicle, for example by means of an optical output device and/or by means of an acoustic output device of the motor vehicle takes place in a step 100.

Additionally or alternatively, the information regarding the determined possible escape route can be transmitted to a driver assistance system of the motor vehicle. The driver assistance system is assigned for the automatic actuating of at least one element of the motor vehicle, for example a braking device, a driving device, a steering device and a warning device. In this case, at least one operating parameter of the motor vehicle is adapted by means of the at least one driver assistance system based on the information regarding the determined possible escape route takes place in the step 100. In particular, a prime mover or engine of the motor vehicle can be automatically deactivated and/or the motor vehicle's lighting can be automatically activated, such as automatic activating of a hazard warning flasher system of the motor vehicle.

Additionally or alternatively, automatic activating at least one lighting device of the motor vehicle based on the information regarding the determined possible escape route can take place in the step 100 in such a manner that the determined possible escape route is located at least partially within a region illuminated by means of the at least one lighting device.

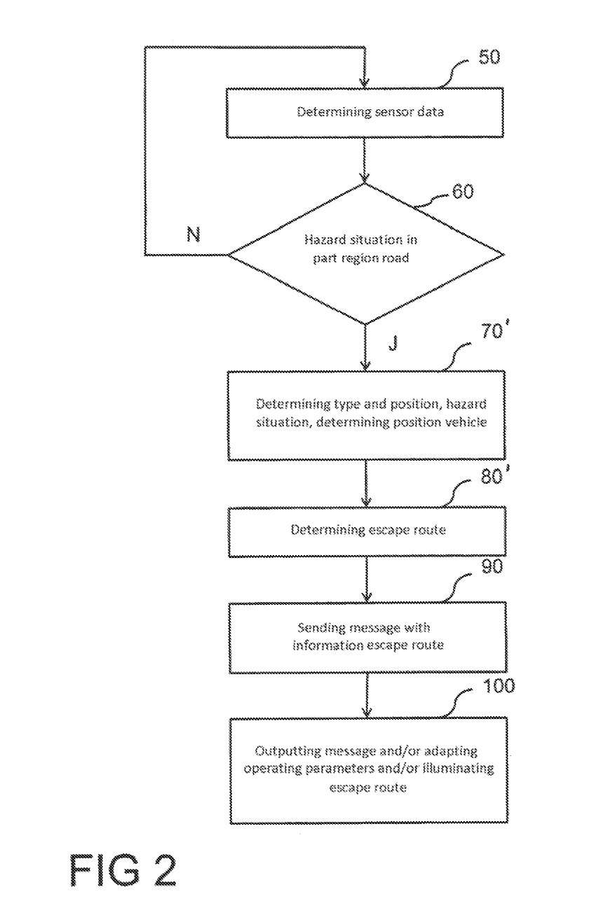

FIG. 2 shows a flow diagram of a method for operating a safety system for a motor vehicle according to a second embodiment of the present disclosure. The motor vehicle, for example, is again a passenger car or a utility vehicle. The safety system includes at least one sending and receiving device or first transceiver arranged in the motor vehicle and at least one vehicle-external infrastructure device. The at least one infrastructure device in this case includes a sending and receiving device or second transceiver and is arranged adjacent to a part region of a road having a limited switching possibility for motor vehicles to switch to a region arranged adjacent to the road, for example in the region of a tunnel

Data is determined by means of at least one sensor arranged adjacent to the part region of the road having a limited switching possibility in a step 50, corresponding to the step 50 of the first embodiment shown in FIG. 1.

In a step 60 it is determined based on the data determined in the step 50 whether there is a possible hazard situation in the part region of the road having an at least limited switching possibility, corresponding to the step 60 of the first embodiment shown in FIG. 1. When in this case it is determined in the step 60 that there is no hazard situation within the part region of the road having an at least limited switching possibility, the steps 50 and 60 are carried out repeatedly. When in the case that, by contrast, it is determined in the step 60 that there is a possible hazard situation in the part region of the road having an at least limited switching possibility, a position of the determined possible hazard situation relative to the at least one vehicle-external infrastructure device is determined in the shown embodiment in a step 70′. In addition, a type of the possible hazard situation is determined, for example based on the sensor data determined in the step 50, takes place in the step 70′. Furthermore, a current position of the motor vehicle is determined in the step 70′ and the position data containing the determined current position of the motor vehicle provided in the at least one infrastructure device. The current position of the motor vehicle is determined in this case for example by means of a satellite-supported position determining device or GPS of the motor vehicle, which can in particular be part of a navigation system of the motor vehicle. The position data in this case is preferably transmitted to the transceiver of the at least one infrastructure device by means of the transceiver arranged in the motor vehicle.

Based on the position and type of the determined possible hazard situation and the current position of the motor vehicle likewise determined in the step 70′, a possible escape route for the motor vehicle and/or its occupants for avoiding the determined possible hazard situation is determined in a step 80′.

In the case that the at least one infrastructure device includes a storage device with map data, wherein the map data contains information regarding a course of the road at least in the part region of the road having a limited switching possibility, the possible escape route for the motor vehicle or its occupants can additionally is determined based on the map data.

A message is sent by means of the transceiver of the at least one infrastructure device to the at least one transceiver of the motor vehicle corresponding to the step 90 of the first embodiment shown in FIG. 1 takes place in a step 90. Here, the message in turn contains information regarding the determined possible escape route for the motor vehicle or its occupants.

Furthermore, a message containing the information regarding the determined possible escape route is output by means of an output device of the motor vehicle. Alternately or additionally, the information regarding the determined possible escape route is transmitted to a driver assistance system of the motor vehicle for adapting at least one operating parameter of the motor vehicle based on the information regarding the determined possible escape route takes place in a step 100. In addition, automatic activating of at least one lighting device of the motor vehicle may be automatically activated based on the information regarding the determined possible escape route in such a manner that the determined possible escape route is at least partially located within a region illuminated by means of the at least one lighting device. Here, the step 100 corresponds to the step 100 of the first embodiment shown in FIG. 1.

By means of the shown embodiments, as rapid as possible a reaction to hazard situations in particular in tunnels and on bridges as an application case for example of the C2I communication is thus made possible. In the case of the C2I technology, a vehicle communicates with a roadside unit (RSU), i.e. a unit permanently installed at a road, which typically has important information for the vehicle. In the case of a C2I tunnel assistant, the RSU can obtain information regarding a possible hazard situation from sensors which are installed in the tunnel, for example smoke detectors, cameras or a motion-recording device. In addition it is also possible that the RSU is supplied with information by a human monitor. In an emergency situation, the RSU can then inform the vehicle of the direction in which an escape would be most favorable. In a configuration of the method, from the vehicle via a human-machine interface, which is also called HMI (human machine interface), this is subsequently transmitted in particular to the driver of the motor vehicle. The vehicle can continue to support the driver in the escape in that it illuminates the escape route as far as possible for example with swiveling headlamps. In a further configuration of the method, the vehicle can likewise react to the message of the RSU by switching off the engine and switching on the hazard warning flasher system when there is a fire for example. In the case that the vehicle is not yet stationary, it can also be autonomously brought to a stop slowly when the RSU reports an accident in traveling direction.

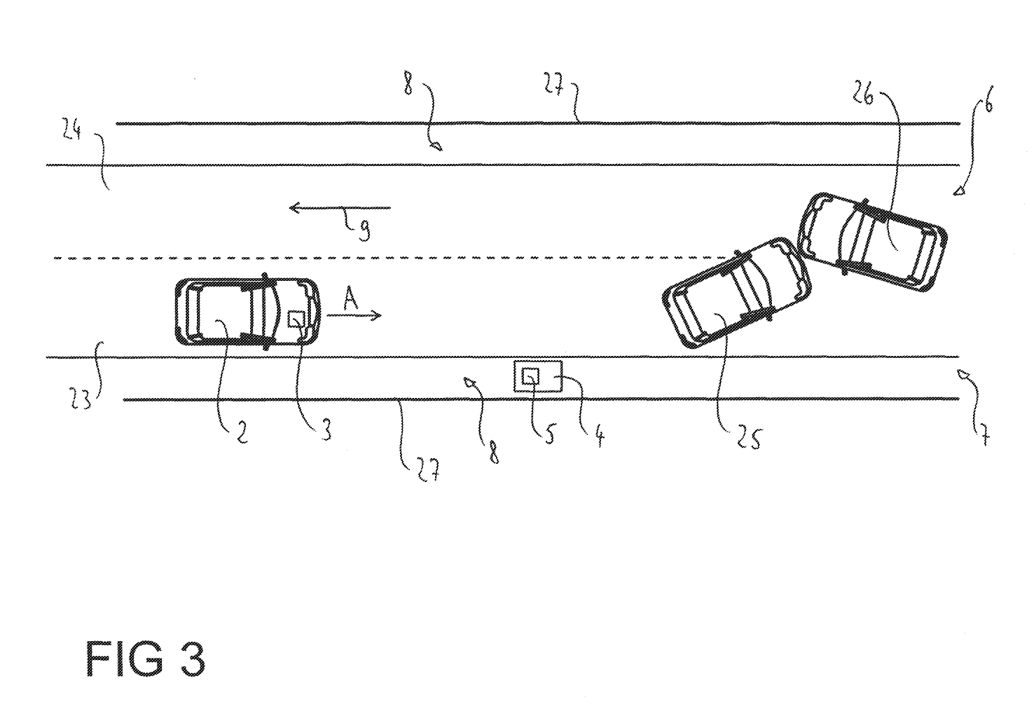

FIG. 3 shows an example of a traffic situation, in which the methods according to the embodiments of the present disclosure, in particular the methods according to the embodiments shown in the FIGS. 1 and 2 can be employed. In the shown traffic situation, a motor vehicle 2 in the form of a passenger motorcar travels in a traveling direction schematically shown by means of an arrow A on a first lane 23 of a road 7. Next to the first lane 23 the road 7 additionally includes a further lane 24. Here, the motor vehicle 2 in the shown traffic situation is in a part region 6 of the road 7 with limited switching possibility for motor vehicles to switch to a region 8 arranged adjacent to the road 7, since the road 7 in the part region 6 is located within a schematically shown tunnel 27.

In traveling direction A of the motor vehicle 2, there is a hazard situation within the tunnel 27 in front of it. The hazard situation in this case is caused by two further motor vehicles 25 and 26 which are involved in a road accident. In the shown hazard situation, the range of vision can be additionally limited at least in a part region of the tunnel 27 through smoke development because of a fire. As is explained in more detail in connection with the following figures, such a hazard situation in the part region 6 of the road 7 having a limited switching possibility and a position of the determined possible hazard situation relative to the vehicle-external infrastructure device 4 can be determined by means of an infrastructure device 4, which is arranged adjacent to the part region 6 of the road 7. Furthermore, the infrastructure device 4 can determine an escape route 9 shown by means of an arrow for avoiding the determined possible hazard situation based on the determined position of the possible hazard situation relative to the infrastructure device 4, and if appropriate additionally based on the current position of the motor vehicle 2 and/or based on a type of the determined possible hazard situation. In addition, a message can be transmitted to a sending and receiving device or transceiver 3 of the motor vehicle by means of a sending and receiving device or transceiver 5 of the infrastructure device 4, wherein the message contains information regarding the determined possible escape route 9.

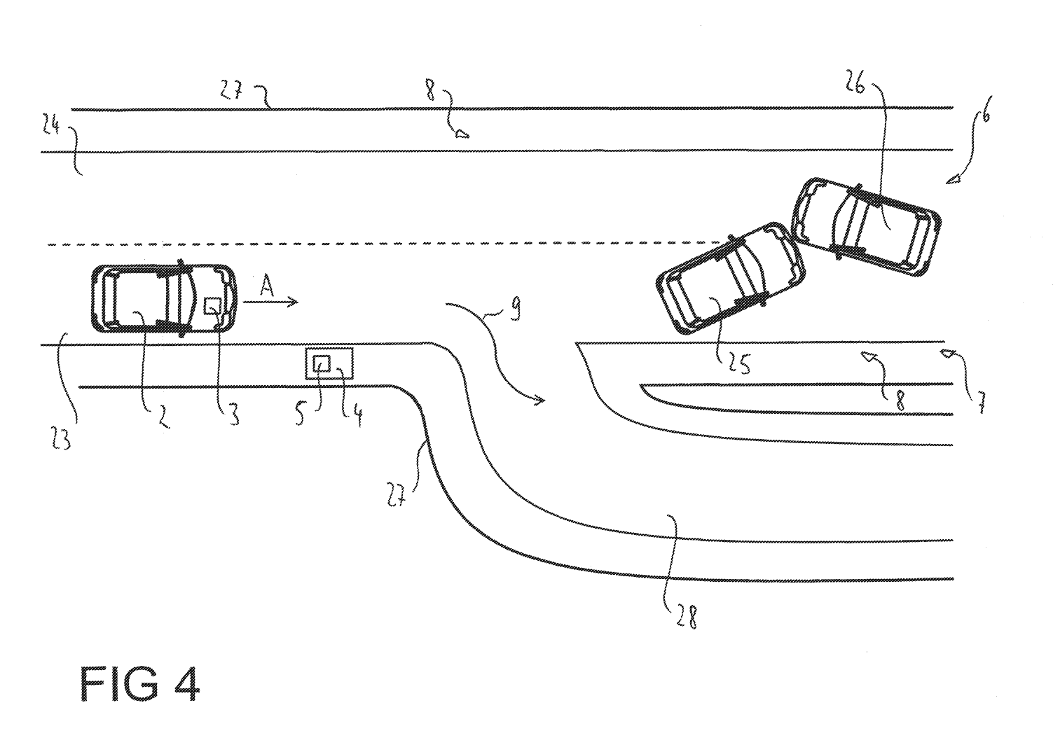

FIG. 4 shows an example of a further traffic situation, in which the methods according to the embodiments of the present disclosure, in particular the methods according to the embodiments shown in the FIGS. 1 and 2 can be employed. Components with the same functions as in FIG. 3 are marked with the same reference characters and are not explained again in the following. The traffic situation shown in FIG. 4 differs from the traffic situation shown in FIG. 3 in that the road 7 in the part region 6 with an at least limited switching possibility includes a further lane 28 in addition to the lanes 23 and 24, which branches off the lane 23 and in the part region 6 is likewise arranged within the tunnel 27. In the shown traffic situation, the motor vehicle 2 in turn travels in the traveling direction of the lane 23 schematically indicated by means of an arrow A, wherein the further lane 28 in traveling direction of the motor vehicle 2 is located between the latter and the location of the hazard situation. As a result, an escape route 9 for avoiding the determined possible hazard situation can be determined by means of the infrastructure device 4 in the shown traffic situation, wherein the escape route 9 directs the motor vehicle 2 from the lane 23 to the further lane 28. To this end, the infrastructure device 4 includes for example a storage device with map data which is not shown in more detail in FIG. 4. The map data contains information regarding a course of the road 7 at least in the part region 6 of the road 7 having a limited switching possibility. Further details are explained in more detail in connection with the following figure.

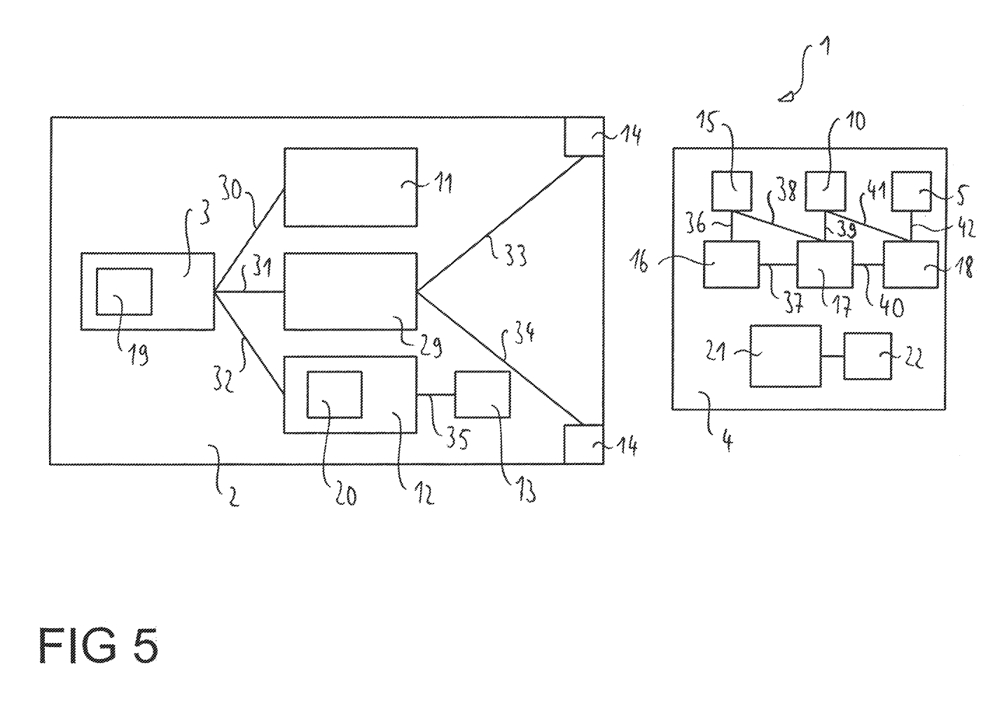

In this regard, FIG. 5 shows a safety system 1 for the motor vehicle 2 shown in FIGS. 3 and 4 according to an embodiment of the present disclosure. Components with the same functions as in the FIGS. 3 and 4 are marked with the same reference characters and not explained again in the following. For the sake of clarity, the motor vehicle 2 is merely shown schematically in FIG. 5. The safety system 1 in addition to the transceiver 3 arranged in the motor vehicle 2 and the at least one vehicle-external infrastructure device 4, which includes the transceiver 5, includes a first determining device 16 configured to determine whether there is a possible hazard situation in the part region of the road having an at least limited switching possibility. The first determining device 16 in the shown embodiment is part of the infrastructure device 4 and connected to at least one sensor 15 via a signal line 36. The at least one sensor 15 is arranged adjacent to the part region of the road having a limited switching possibility and in the shown embodiment within the infrastructure device 4. The at least one sensor 15 is for example designed as a smoke detector or as an optical camera.

In addition, the safety system 1 includes a second determining device 17 configured to determine a position of the determined possible hazard situation relative to the vehicle-external infrastructure device 4 in the case that it is determined that there is a possible hazard situation in the part region of the road having an at least limited switching possibility. The second determining device 17 in the shown embodiment is likewise part of the infrastructure device 4 and connected to the first determining device 16 via a signal line 37 and to the at least one sensor 15 via a signal line 38 and to a storage device 10 via a signal line 39. The storage device 10 contains map data with information regarding a course of the road at least in the part region of the road having a limited switching possibility.

Furthermore, the safety system 1 includes a third determining device 18 configured to determine a possible escape route for avoiding the determined possible hazard situation. The third determining device 18 in the shown embodiment is likewise part of the infrastructure device 4 and designed for determining the possible escape route based on the determined position of the possible hazard situation relative to the infrastructure device 4 and additionally based on a determined current position on the motor vehicle 2 and based on the map data stored in the storage device 10. For this purpose, the third determining device 18 is connected to the second determining device 17 via a signal line 40, to the storage device 10 via a signal line 41 and to the transceiver 5 of the infrastructure device 4 via a signal line 42. The current position of the motor vehicle 2 can thus be transmitted to the transceiver 5 of the infrastructure device 4 by means of the transceiver 3 of the motor vehicle 2. Furthermore, the third determining device 18 may be configured to determine a type of the possible hazard situation. In this case, the third determining device 18 is configured in such a manner that determining the possible escape route additionally takes place based on the determined type of the possible hazard situation.

The infrastructure device 4 is configured to send a message containing information regarding the determined possible escape route by means of the transceiver 5 to the transceiver 3 of the motor vehicle 2. In the shown embodiment, the transceiver 3 of the motor vehicle 2 for this purpose includes a vehicle-to-infrastructure communication device 19. Furthermore, the motor vehicle 2 includes an output device 11, which is designed for outputting a message within the motor vehicle 2 containing the information regarding the determined possible escape route. The output device 11 to this end is connected to the transceiver 3 via a signal line 30, and for example is designed as an optical output device and/or acoustic output device.

In addition to this, the motor vehicle 2 in the shown embodiment includes an adapting device 20 configured to adapt at least one operating parameter of the motor vehicle 2 by means of at least one driver assistance system 12 of the motor vehicle 2 based on the information regarding the determined possible escape route. The driver assistance system 12 is designed in order to automatically actuate at least one element 13 of the motor vehicle 2, for example a braking device, a driving device and a steering device. The adapting device 20 in the shown embodiment is part of the driver assistance system 12, which is connected to the transceiver 3 via a signal line 32 and to the at least one element 13 of the motor vehicle 2 via a signal line 35.

In addition, the motor vehicle 2 includes an activation unit 29, configured to automatic activate lighting devices 14 of the motor vehicle 2 based on the information regarding the determined possible escape route in such a manner that a determined possible escape route is located at least partially within a region illuminated by means of the lighting devices 14. The activating unit 29 is additionally connected to the transceiver 3 via a signal line 31 and to the lighting devices 14 via signal lines 33 and 34, which for example are designed as swiveling headlamps of the motor vehicle 2.

Furthermore, the safety system 1 in the shown embodiment includes a computer unit 21 and a computer-readable medium 22 storing a computer program product which, when executed on the computer unit 21, instructs the computer unit 21 to carry out the steps mentioned in connection with the embodiments of the method, in particular steps of the embodiments shown in the FIGS. 1 and 2 by means of the elements thereby mentioned. To this end, the computer unit 21 is directly or indirectly connected to the relevant element in a manner which is not shown in more detail. The computer unit 21 and the computer-readable medium 22 in the shown embodiment are part of the infrastructure device 4.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. A method for operating a safety system for a motor vehicle, wherein the safety system includes a first transceiver arranged in the motor vehicle and at least one vehicle-external infrastructure device having a second transceiver and arranged adjacent to a part region of a road having a limited switching possibility for motor vehicles to switch to a region arranged adjacent to the road, the method comprising:
determining when there is a possible hazard situation in the part region of the road with a limited switching possibility;
determining a position of the determined possible hazard situation relative to the at least one vehicle-external infrastructure device when it has been determined that there is a possible hazard situation in the part region of the road with a limited switching possibility;
determining a possible escape route for avoiding the determined possible hazard situation based on the determined position of the possible hazard situation relative to the at least one vehicle-external infrastructure device; and
sending a message containing information regarding the determined possible escape route by means of the second transceiver to the first transceiver.

17. The method according to claim 16, further comprising:
determining a current position of the motor vehicle; and
providing position data containing the determined current position of the motor vehicle in the at least one infrastructure device;
wherein determining of the possible escape route additionally based on the position data containing the determined current position of the motor vehicle.

18. The method according to claim 16, wherein the at least one infrastructure device includes a storage device with map data containing information regarding a course of the road in at least the part region of the road with a limited switching possibility, and further comprising determining the possible escape route based on the map data.

19. The method according to claim 16 further comprising determining a type of the determined possible hazard situation, and wherein the possible escape route is determined based on the determined type of the determined possible hazard situation.

20. The method according to claim 16 further comprising outputting a message containing the information regarding the determined possible escape route is affected by an output device of the motor vehicle.

21. The method according to claim 16 further comprising transmitting the information regarding the determined possible escape route to at least one driver assistance system of the motor vehicle and adapting at least one operating parameter of the motor vehicle by automatically actuating at least one element of the motor vehicle with the at least one driver assistance system based on the information, wherein the least one element of the motor vehicle selected from the group consisting of a braking device, a driving device, a steering device and a warning device.

22. The method according to claim 21, wherein adapting the at least one operating parameter of the motor vehicle includes at least one of automatic deactivating of a prime mover of the motor vehicle and automatic activating of at least one lighting device of the motor vehicle.

23. The method according to claim 16 further comprising automatic activating of at least one lighting device of the motor vehicle based on the information regarding the determined possible escape route takes in such a manner that the determined possible escape route is at least partly located within a region illuminated by the at least one lighting device.

24. The method according to claim 16, wherein whether a possible hazard situation in the part region of the road having a limited switching possibility is determined by the at least one infrastructure device based on data determined by at least one sensor arranged adjacent to the part region of the road having a limited switching possibility.

25. A safety system for a motor vehicle comprising:
a first transceiver arranged in the motor vehicle;
at least one vehicle-external infrastructure device having a second transceiver and configured to be arranged adjacent to a part region of a road having a limited switching possibility for motor vehicles to switch to a region arranged adjacent to the road;
a first determining device configured to determine when a possible hazard situation is present in the part region of the road with a limited switching possibility;
a second determined device configured to determine a position of the determined possible hazard situation relative to the at least one vehicle-external infrastructure device when there is a possible hazard situation in the part region of the road with an at least limited switching possibility; and
a third determining device configured to determine a possible escape route for avoiding the determined possible hazard situation based on the determined position of the possible hazard situation relative to the at least one vehicle-internal infrastructure device;
wherein at least one vehicle-external infrastructure device is configured to send a message containing information regarding the determined possible escape route to the first transceiver by the second transceiver.

26. The safety system according to claim 25, wherein the first transceiver comprises a vehicle-to-infrastructure communication device.

27. The safety system according to claim 25 further comprising an output device configured to output a message within the motor vehicle containing the information regarding the determined possible escape route.

28. The safety system according to claim 25 further comprising at least one driver assistance system having an adapting device configured to adapt at least one operating parameter of the motor vehicle based on the information regarding the determined possible escape route.

29. A computer program product which, when executed on a computer unit of a safety system for a motor vehicle of the type having a first transceiver arranged in the motor vehicle and a t least one vehicle-external infrastructure device having a second transceiver arranged adjacent to a part region of a road having a limited switching possibility for motor vehicles to switch to a region arranged adjacent to the road, instructs the computer unit to carry out the following process:
determining whether a possible hazard situation exists in the part region of the road with a limited switching possibility;
determining a position of the determined possible hazard situation relative to the at least one vehicle-external infrastructure device when a possible hazard situation exists in the part region of the road with a limited switching possibility;
determining a possible escape route for avoiding the determined possible hazard situation based on the determined position of the possible hazard situation relative to the at least one vehicle-external infrastructure; and
sending a message containing information regarding the determined possible escape route by the second transceiver to the first transceiver of the motor vehicle.

30. A non-transitory computer-readable medium storing the computer program product according to claim 29.
